(19) United States
(12) Patent Application Publication
(10) Pub. No.: US 2026/0147656 A1
(43) Pub. Date: May 28, 2026

(54) SYSTEMS AND METHODS FOR REMOTELY TROUBLESHOOTING A DIGITAL VIDEO RECORDER DEVICE IN REAL-TIME

(71) Applicants: Getac Technology Corporation, Taipei City (TW); WHP Workflow Solutions, Inc., North Charleston, SC (US)

(72) Inventor: Muhammad Adeel, Edina, MN (US)

(73) Assignees: Getac Technology Corporation, Taipei City (TW); WHP Workflow Solutions, Inc., North Charleston, SC (US)

(21) Appl. No.: 19/359,660

(22) Filed: Oct. 15, 2025

Related U.S. Application Data
(60) Provisional application No. 63/724,804, filed on Nov. 25, 2024.

(51) Int. Cl. G06F 11/07

(52) U.S. Cl. CPC G06F 11/0769; G06F 11/0748

(57) ABSTRACT

A real-time remote troubleshooting system is communicatively connected to a device and a remote console. The real-time remote troubleshooting system includes a memory and a processor. The memory is configured to store instructions. The processor is electrically coupled to the memory and is configured to execute the instructions to: receive a request for remote access to the device from the remote console; provide the remote console with the remote access to the device based on the request; collect logs associated with the device; display the collected logs on the remote console; display information associated with the device on the remote console; and perform an action based on a feedback from the remote console, wherein the feedback is generated corresponding to the collected logs and the displayed information.

### CROSS-REFERENCE TO RELATED APPLICATION

This application claims the benefit of priority to U.S. Provisional Application No. 63/724,804, filed Nov. 25, 2024, which is herein incorporated by reference in its entirety.

### BACKGROUND

### Technical Field

The present disclosure relates to a troubleshooting system and method. More particularly, the present disclosure relates to a real-time remote troubleshooting system and method for a digital video recorder and/or a body-worn camera.

### Description of Related Art

Public safety information technology (IT) personnel need to have ready access to real-time information about status of a digital video recorder (DVR) and/or a body-worn camera (BWC). As a public safety support or station IT user, the goal is to quickly access to the real-time information (i.e., in a management platform about the status of the DVR and/or BWC to help the customer (e.g., a police officer) to diagnose issues efficiently without the need to rely on additional tools.

Currently, the remote troubleshooting procedure is time-intensive. In practice, if the police officer encounters a technical issue in the field, the available time for troubleshooting is often minimal. Furthermore, the police officer using the device (e.g., DVR and/or BWC) requires perfect functionality without delay. Even with the slightest technical issue, the police officer may disengage the device entirely. Furthermore, some troubleshooting procedure may temporarily reduce police resources.

### SUMMARY

Consistent with embodiments of the present disclosure, a real-time remote troubleshooting system is provided. The real-time remote troubleshooting system is communicatively connected to a device and a remote console. The real-time remote troubleshooting system includes a memory and a processor. The memory is configured to store instructions. The processor is electrically coupled to the memory and is configured to execute the instructions to: receive a request for remote access to the device from the remote console; provide the remote console with the remote access to the device based on the request; collect logs associated with the device; display the collected logs on the remote console; display information associated with the device on the remote console; and perform an action based on a feedback from the remote console, wherein the feedback is generated corresponding to the collected logs and the displayed information.

Furthermore, consistent with embodiments of the present disclosure, another real-time remote troubleshooting system is provided. The real-time remote troubleshooting system includes a digital video recorder and a troubleshooting apparatus. The digital video recorder is communicatively connected to a body-worn camera. The digital video recorder is configured to store logs associated with the body-worn camera. The troubleshooting apparatus is communicatively connected to the digital video recorder and a remote console, and is configured to: receive a request for remote access to the digital video recorder from the remote console; provide the remote console with the remote access to the digital video recorder based on the request; collect logs associated with the digital video recorder or the body-worn camera; display the collected logs on the remote console; display information associated with the digital video recorder or the body-worn camera on the remote console; and perform an action based on a feedback from the remote console, wherein the feedback is generated corresponding to the collected logs and the displayed information.

Furthermore, consistent with embodiments of the present disclosure, a real-time remote troubleshooting method is provided. The real-time remoted troubleshooting method is suitable for an electronic device that is communicatively connected to a device and a remote console. The real-time remote troubleshooting method includes: receiving a request for remote access to the device from the remote console; providing the remote console with the remote access to the device based on the request; collecting logs associated with the device; displaying the collected logs on the remote console; displaying information associated with the device on the remote console; and performing an action based on a feedback from the remote console, wherein the feedback is generated corresponding to the collected logs and the displayed information.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram illustrating a real-time remote troubleshooting system according to an embodiment of the present disclosure;

FIG. 2 is a block diagram illustrating a real-time remote troubleshooting system according to another embodiment of the present disclosure;

FIG. 3 is a schematic view illustrating a portal according to an embodiment of the present disclosure;

FIG. 4 is a flowchart illustrating a real-time remote troubleshooting method according to an embodiment of the present disclosure; and

FIG. 5 is a flowchart illustrating a real-time remote troubleshooting method according to another embodiment of the present disclosure.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present disclosure belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

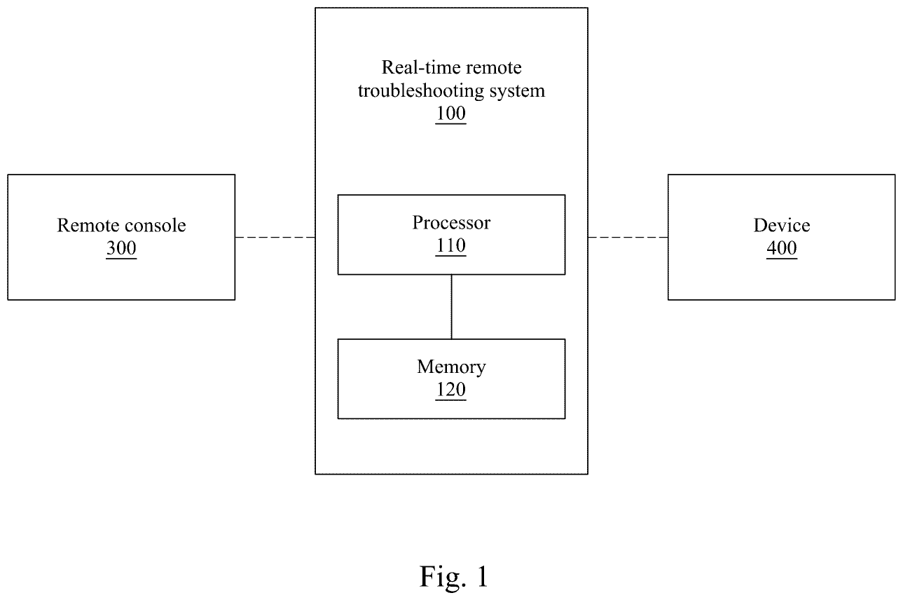

FIG. 1 is a block diagram illustrating a real-time remote troubleshooting system 100 according to an embodiment of the present disclosure.

As shown in FIG. 1, the real-time remote troubleshooting system 100 includes a processor 110 and a memory 120, and communicatively connected to a device 400 and a remote console 300. The device 400 may include a body-worn camera (BWC) and/or a digital video recorder (DVR). The remote console 300 may be a personal computer used by a user (e.g., support team or customer of the device 400).

The real-time remote troubleshooting system 100 may include Bluetooth module, Wi-Fi module, and/or other communication interfaces for communicatively connecting to other devices.

The memory 120 is configured to store instructions. The memory 120 may include semiconductor or solid-state memory, magnetic tapes, removable computer disks, random access memory (RAM), read-only memory (ROM), a hard disk, optical disks, and/or other suitable storage units.

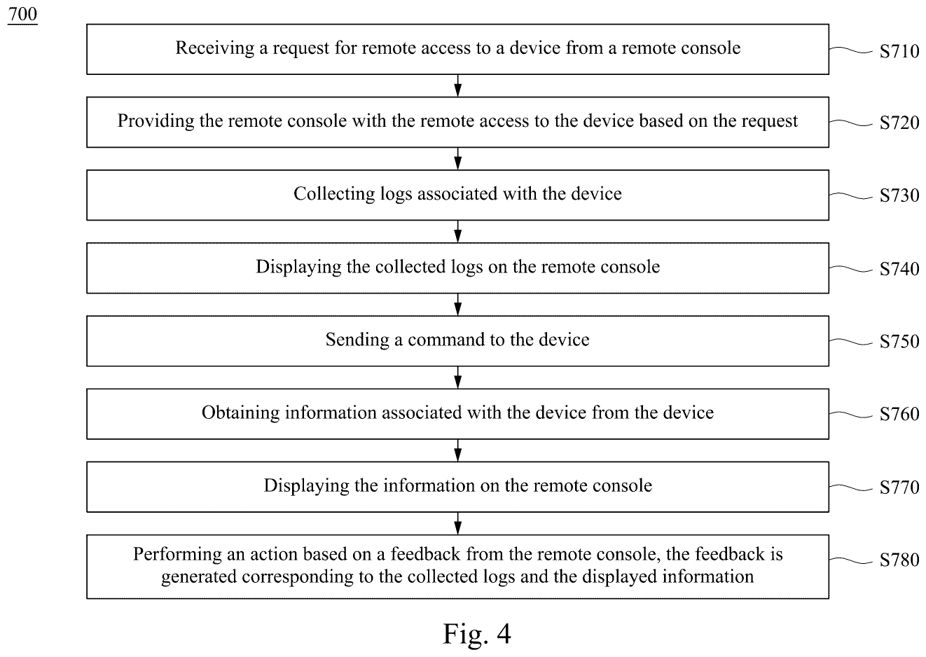

The processor 110 is electrically coupled to the memory 120, and is configured to execute the instructions to perform a real-time remote troubleshooting method 700 (see FIG. 4). The processor 110 may include central processing units (CPU), graphics processing units (GPU), multiprocessors, distributed processing systems, application specific integrated circuits (ASIC), and/or other suitable computing units.

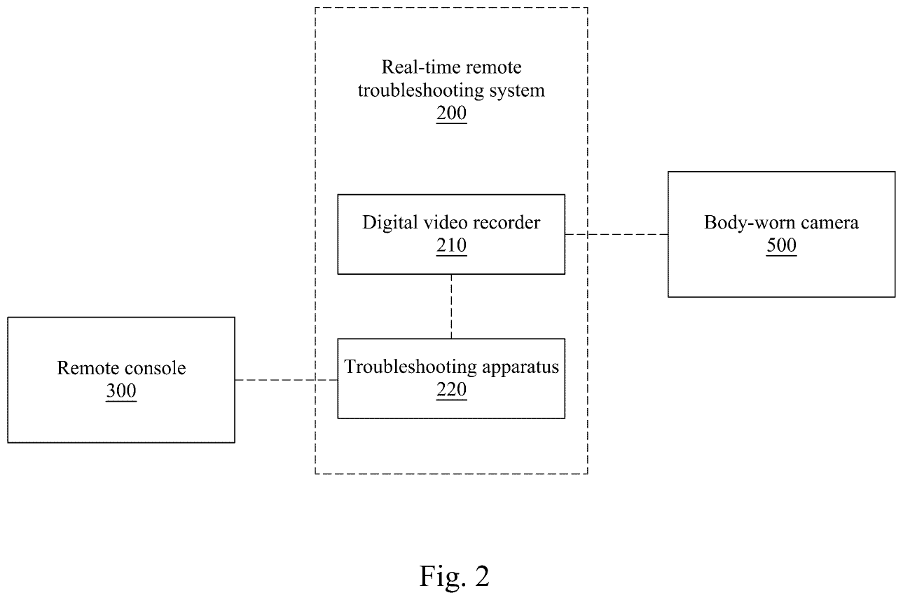

FIG. 2 is a block diagram illustrating a real-time remote troubleshooting system 200 according to another embodiment of the present disclosure. The real-time remote troubleshooting system 200 includes a digital video recorder (DVR) 210 and a troubleshooting apparatus 220. The digital video recorder 210 communicatively connected to a body-worn camera (BWC) 500. The digital video recorder 210 is configured to store logs associated with the body-worn camera 500 and store a plurality of images captured by the body-worn camera 500 in a database. The troubleshooting apparatus 220 is communicatively connected to the digital video recorder 210 and the body-worn camera 500.

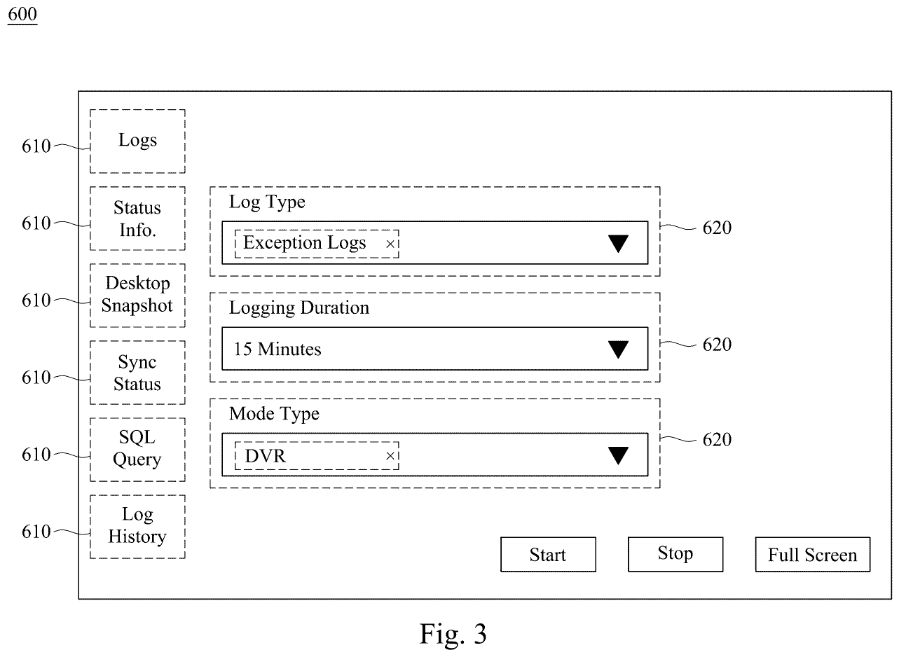

FIG. 3 is a schematic view illustrating a portal 600 according to an embodiment of the present disclosure. The portal 600 is provided by the processor 110 of the real-time remote troubleshooting system 100 or the troubleshooting apparatus 220. Specifically, the portal 600 is a software-based manipulation interface (e.g., web page, application window) executed by the processor 110 or the troubleshooting apparatus 220. The portal 600 may include a plurality of tabs 610. Each of the tabs 610 may include one or more fields 620. In the example of FIG. 2, the portal 600 includes six tabs 610: Logs, Status Info., Desktop Snapshot, Sync Status, SQL Query, and Log History. In addition, the Logs tab 610 includes three fields 620: Log Type, Logging Duration, and Mode Type, to specify which logs should be displayed and for how long. The Log Type field 620 is a multi-select dropdown menu with four options: Debug Logs, Diagnostics Logs, Audits Logs, and Exception Logs. The Logging Duration field 620 is a single-select dropdown menu with three options: 15 Minutes, 4 Hours and 24 Hours. The Mode Type field 620 may be a multi-select dropdown menu with two options: DVR (e.g., the DVR 210), and DSS (Data Sync Service). The portal 600 may be accessed by the remote console 300 so that the portal 600 may be displayed on a display panel (not shown) of the remote console 300.

FIG. 4 is a flowchart illustrating the real-time remote troubleshooting method 700 according to an embodiment of the present disclosure. The real-time remote troubleshooting method 700 is suitable for an electronic device that communicatively connected with a device and a remote console. The electronic device may be the real-time remote troubleshooting system 100 or 200. To simplify the description below, the embodiment shown in FIG. 1 will be used to describe the real-time remote troubleshooting method 700.

As shown in FIG. 4, the real-time remote troubleshooting method 700 includes steps S710 to S780.

In step S710, receiving a request for remote access to the device from a remote console. For example, when the user of the remote console 300 logs in the portal 600 provided by the processor 110 of the real-time remote troubleshooting system 100, the processor 110 receives the request for the device 400 (e.g., DVR) from the remote console 300 through the portal 600.

In step S720, providing the remote console with the remote access to the device based on the request. Specifically, the processor 110 decides whether or not to grant the request, when the processor 110 decides to grant the request, the processor 110 provides the remote console 300 with the remote access through the portal 600 and the remote console 300 starts a session with the device 400.

In step S730, collecting logs associated with the device.

In step S740, displays the collected logs on the remote console.

In some embodiments, the real-time remote troubleshooting method 700 further includes: displaying a plurality of user interface components (e.g., the tabs 610 and/or fields 620 of the portal 600) on the remote console 300; selecting one of the user interface components based on a display parameter; and displaying the selected user interface components corresponding to the display parameter. The display parameter may be generated corresponding to the user's operation. For example, the user selects one of the tabs 610 and/or fields 620 in the portal 600 using the remote console 300, the display parameter indicating the selected tab 610 or field 620 is generated correspondingly. The display parameter may be an identification number of the selected tab 610 or field 620.

For example, the user of the remote console 300 selects the Logs tab 610 on the portal 600, the processer 110 displays the Logs tab 610 and collects logs associated with the device 400 (e.g., logs of DVR, logs of BWC), and the Logs tab 610 of the portal 600 displays the collected logs to the remote console 300.

In some embodiments, the real-time remote troubleshooting method 700 further includes: selecting a specific log type from log types corresponding to the collected logs; and displaying the collected logs associated with the specific log type on the remote console 300.

In some embodiments, the real-time remote troubleshooting method 700 further includes: obtaining a specific time duration; collecting the logs associated with the device for the specific time duration; and displaying the logs associated with the device that were collected within the specific time duration.

In some embodiments, the real-time remote troubleshooting method 700 further includes: obtaining a specific mode type; and displays the collected logs associated with the specific mode type on the remote console.

Specifically, the specific log type, the specific time duration, and the specific mode type may be obtained based on the user's selection in the fields 620 of the Logs tab 610.

For example, when the user selects ‘Exception Logs’ in the Log Type field 620 of the Logs tab 610, the specific log type is selected correspondingly, and the processor 110 displays the exception logs of the device 400 on the remote console 300 through the Logs tab 610 of the portal 600.

For example, when the user selects ‘15 Minutes’ in the Logging Duration field 620 of the Logs tab 610, the specific time duration is selected correspondingly, and the processor 110 displays the logs of the device 400 that were collected in 15 minutes on the remote console 300 through the Logs tab 610 of the portal 600.

For example, when the user selects ‘DVR’ in the Mode Type field 620 of the Logs tab 610, the specific mode type is selected correspondingly, and the processor 110 displays DVR logs on the remote console 300 through the Logs tab 610 of the portal 600. The DVR logs records information related to the operation, status, and events occurring in the DVR. On the other hand, when the user selects ‘DSS’ in the Mode Type field 620 in the Logs tab 610, the processor displays the DSS logs, which record detailed information related to data synchronizations, such as data transfer logs, connection status, etc.

It should be noted that the user may make selection in multiple fields 620. For example, the user selects ‘Debug Logs’ in the Log Type field 620 and selects ‘4 Hours’ in the Logging Duration field 620, the debug logs of the device 400 that were collected in 4 hours are displayed correspondingly.

In step S750, sending a command to the device.

In step S760, obtaining information associated with the device from the device.

In step S770, displaying the information on the remote console through the portal.

Specifically, the command is generated correspondingly when the user selects any one of the Status Info. tab 610, the Desktop Snapshot tab 610, the Sync Status tab 610, and the SQL Query tab 610. The information may include any one of status information, screenshot, synchronization information, and query result of the device 400 (e.g. DVR or BWC). The displayed logs and information may be helpful for troubleshooting in critical situations, where the objective is minimizing the downtime of the system.

When the user selects the Status Info. tab 610, the processor 110 generates the command correspondingly and sends the command to the device 400. In response to the command, the device 400 sends the status information to the processor 110. The processor 110 displays the status information on the remote console 300 through the Status Info. tab 610 of the portal 600. The status information may be a detailed list of the specification of the device 400, may include information about total assets, transferred assets, hold assets, deleted assets, error assets, queued assets, queued assets size, uploading status, available space, temperature, battery, CPU, and/or memory of the device 400. In some embodiments, the status information may further include information about total space, space remaining, CPU data, RAM data, temperature data, and version data.

Similarly, when the user selects the Desktop Snapshot tab 610, the processor 110 generates the command correspondingly. In response to the command, the device 400 generates a screenshot of the device 400 and sends the screenshot to the processor 110. The processor 110 obtains the screenshot from the device 400 and displays the screenshot on the remote console 300 through the Desktop Snapshot tab 610 of the portal 600. The screenshot may be a real-time image of the operating system user interface of the device 400, which may be used to determine whether errors have occurred at the operating system level.

When the user selects the Sync Status tab 610, the processor 110 displays the synchronization information on the remote console 300 through the Sync Status tab 610. The synchronization information may include logs from the MQTT (Message Queuing Telemetry Transport) synchronization system on the device 400, which serve to monitor and record the status of message transmission.

When the user selects the SQL Query tab 610, the processor 110 sends the command to the device 400 (e.g. DVR) to query a database of the device 400. The device 400 queries the database based on the command to generate a query result. The processor 110 obtains the query result corresponding to the command from the device 400 and displays the query result on the remote console 300 through the SQL Query tab 610.

In a case that the device 400 is DVR, the database of the DVR stores images captured by the BWC, the query result may include information about images that are failing to upload, but not limited thereto.

In some embodiments, the processor 110 of the real-time remote troubleshooting system 100 further displays information associated with the real-time remote troubleshooting method 100. For example, when the user selects the Log History tab 610, the processor 110 displays the log history, which may include detailed logs and/or log data from past use of the real-time remote troubleshooting system 100. The log history may include records of activities and events that have occurred within the real-time remote troubleshooting system 100 during past usage. Specifically, the log history may include detailed logs that capture user actions, system responses, access times, and any changes made to the system settings or data. Additionally, the log history may provide timestamps for each event, user identification, and descriptions of the actions performed, offering a thorough audit trail. The log history may be used to monitor system performance, troubleshooting issues, ensuring security, and maintaining compliance with regulatory requirements. By keeping a meticulous log history, administrators can gain valuable insights into system usage patterns and detect any unauthorized access or anomalies.

In step S780, performing an action based on a feedback from the remote console, wherein the feedback is generated corresponding to the collected logs and the displayed information. For example, the user of the remote console 300 may diagnose the device 400 according to the displayed logs and/or information, and may perform an operation on the portal 600 using the remote console 300 to troubleshoot the device 400, which serves as the feedback used in step S780.

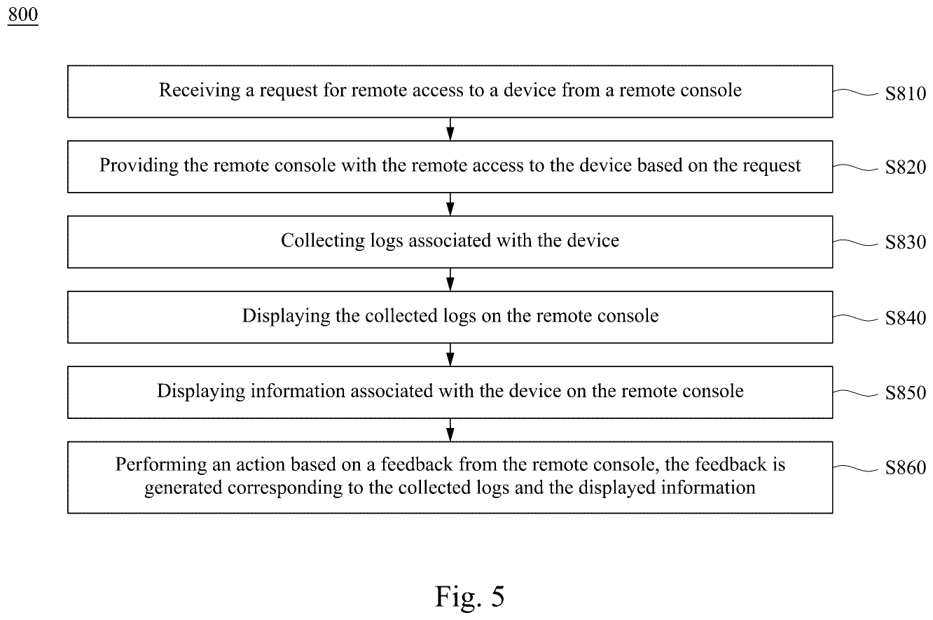

Referring to FIG. 5, FIG. 5 is a flowchart illustrating a real-time remote troubleshooting method 800 according to another embodiment of the present disclosure. The difference between the real-time remote troubleshooting method 700 and 800 is in that step S750 and S760 of the real-time remote troubleshooting method 700 are omitted in the real-time remote troubleshooting method 800. Steps S810 to S860 of the real-time remote troubleshooting method 800 correspond to steps S710 to S740 and steps S770 to S780 of the real-time remote troubleshooting method 700, therefore the detail thereof is omitted herein for the sake of brevity.

In some embodiments, the portal 600 may be an existing portal with appended tabs.

In some embodiments, the portal 600 may be designed to have a plurality of sections. For instance, one section might display current system performance metrics such as CPU usage, memory consumption, and network activity. Another section could focus on error logs and alerts of the device 400, highlighting any issues that need immediate attention. Additionally, there might be a section dedicated to user activity, showing who is currently logged in and what actions they are performing. Other sections could include detailed reports on system health, security status, and historical data trends. By organizing these information into these sections, the user can quickly access and interpret critical information, facilitating efficient system management and troubleshooting.

In some embodiments, the real-time remote troubleshooting system 100 may communicatively connected to a plurality of remote consoles (not shown). That is to say, the portal 600 may be accessed simultaneously by multiple remote consoles. Correspondingly, the real-time remote troubleshooting method 700 may further include steps of receiving a plurality of requests for remote access to the device from the remote consoles respectively; granting one of the requests; providing one of the remote consoles with remote access to the device, based on the granted request; and displaying the information associated with the device on the one of the remote consoles corresponding to the granted request.

In sum, the portal 600 may be accessed by the support team or the customer (i.e., user of the remote console). The portal 600 is configured to display information in real-time to the support team and/or the customer to assist with the remote troubleshooting process. Granting access to the support team or the customer provides an added level of transparency, as all parties may be able to acquire information about the issue. Allowing the customer to access the portal 600 to perform the user's own troubleshooting offers several advantages, such as increasing self-sufficiency, adding transparency, and reducing the need for technical support resources; for example, enabling the customer to troubleshoot own device 400 may minimize the need to contact the support team for simple issues.

In some embodiments, the device 400 may halt sending logs and/or information upon receiving a command and/or automatically.

In some embodiments, the real-time remote troubleshooting system 100, 200 may further generate a command to start writing Global Positioning System (GPS) logs with Expiry.

In some embodiments, the real-time remote troubleshooting system 100, 200 may further generate a command to set log verbosity level. This command may allow the user to configure the logging behavior of the real-time remote troubleshooting system 100, 200 according to the user's specific needs. For example, the user may choose between different log verbosity levels such as verbose, standard, or minimal. In verbose level, the real-time remote troubleshooting system 100, 200 captures detailed information about every event and action, providing a comprehensive record that is useful for in-depth analysis and troubleshooting. In standard level, only logs related to essential events and actions may be captured for balancing detail with storage efficiency. In minimal level, only logs related to critical events may be captured, thereby conserving system resources while still maintaining a basic audit trail. By offering a command to set log verbosity level, the real-time remote troubleshooting system 100, 200 provides flexibility in how logging is managed, enabling the user to tailor the level of detail and storage requirements to their operational needs and preferences. This feature is particularly valuable in environments where system performance and storage capacity are critical considerations.

In some embodiments, the real-time remote troubleshooting system 100 may communicatively connected to a plurality of devices (not shown), and the real-time remote troubleshooting system 100 may further include an indication on one of the device that is being actively diagnosed or troubleshot.

In some embodiments, the real-time remote troubleshooting system 100, 200 and method 700 of the present disclosure may be improved and/or evolved over time based on feedback from the support team and/or the customers.

In some embodiments, data on the console area may be cached for a session. The real-time remote troubleshooting system 100 may temporarily store data generated or accessed during a user's session in the console area. By caching this data, the real-time remote troubleshooting system 100 may improve performance and responsiveness, as frequently accessed information may be quickly retrieved without needing to be reloaded from the primary data source each time. This approach can be particularly beneficial in scenarios where the user need to repeatedly access the same data or perform similar operations within a single session. Additionally, caching data for a session may help reduce the load on the system's backend, leading to more efficient resource utilization. Once the session ends, the cached data can be cleared to free up memory and ensure that the real-time remote troubleshooting system 100 remains optimized for future sessions. This feature enhances the overall user experience by providing faster access to necessary information and smoother interaction with the system.

Another aspect of the present disclosure is directed to a non-transitory computer readable medium storing instructions. When the instructions are executed by a processor that communicates with a device (for example, DVR and/or BWC), the processor executes the real-time remote troubleshooting method 700 discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be appreciated that the present disclosure is not limited to the exact construction that has been described above and illustrated in the accompanying drawings, and that various modifications and changes can be made without departing from the scope thereof. It is intended that the scope of the application should only be limited by the appended claims.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted. Furthermore, while some of the exemplary embodiments of the computerized methods were described using Java language or C to illustrate exemplary scripts and routines, the disclosed methods and systems may be implemented using alternative languages. The disclosed embodiments may use one or multiple programming languages in addition to Java or C. For example, the disclosed embodiments may also be implemented using Python, C++, C#, R, Go, Swift, Ruby, and/or their combinations.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

What is claimed is:

1. A real-time remote troubleshooting system, communicatively connected to a device and a remote console, wherein the real-time remote troubleshooting system comprises:
a memory, configured to store instructions; and
a processor, electrically coupled to the memory, and configured to execute the instructions to:
receive a request for remote access to the device from the remote console;
provide the remote console with the remote access to the device based on the request;
collect logs associated with the device;
display the collected logs on the remote console;
display information associated with the device on the remote console; and
perform an action based on a feedback from the remote console, wherein the feedback is generated corresponding to the collected logs and the displayed information.

2. The real-time remote troubleshooting system of claim 1, wherein the processor provides a user interface, the processor is configured to execute the instructions to:
receive the request for remote access to the device from the remote console through the user interface;
provide the remote console with the remote access to the device through the user interface, based on the request;
display the collected logs on the remote console through the user interface; and
display the information associated with the device on the remote console through the user interface.

3. The real-time remote troubleshooting system of claim 1, wherein the processor is further configured to execute the instructions to:
select a specific log type from a plurality of log types corresponding to the collected logs; and
display the collected logs associated with the specific log type on the remote console.

4. The real-time remote troubleshooting system of claim 1, wherein the processor is further configured to execute the instructions to:
obtain a specific time duration; and
collect the logs associated with the device for the specific time duration.

5. The real-time remote troubleshooting system of claim 1, communicatively connected to a plurality of remote consoles, the processor is further configured to execute the instructions to:
receive a plurality of requests for remote access to the device from the remote consoles respectively;
grant one of the requests;
provide one of the remote consoles with remote access to the device, based on the granted request; and
display the information associated with the device on the one of the remote consoles corresponding to the granted request.

6. The real-time remote troubleshooting system of claim 1, wherein the processor is further configured to execute the instructions to:
send a command to the device to generate a screenshot of the device;
obtain the screenshot from the device; and
display the screenshot of the device on the remote console.

7. The real-time remote troubleshooting system of claim 1, wherein the processor is further configured to execute the instructions to:
send a command to the device to query a database of the device;
obtain a query result corresponding to the command from the device; and
display the query result of the device on the remote console.

8. The real-time remote troubleshooting system of claim 1, wherein the processor is further configured to execute the instructions to:
display a plurality of user interface components on the remote console;
select one of the user interface components based on a display parameter; and
display the selected user interface component corresponding to the display parameter.

9. A real-time remote troubleshooting system, comprising:
a digital video recorder, communicatively connected to a body-worn camera, wherein the digital video recorder is configured to store logs associated with the body-worn camera; and
a troubleshooting apparatus, communicatively connected to the digital video recorder and a remote console, and configured to:
receive a request for remote access to the digital video recorder from the remote console;
provide the remote console with the remote access to the digital video recorder based on the request;
collect logs associated with the digital video recorder or the body-worn camera;
display the collected logs on the remote console;
display information associated with the digital video recorder or the body-worn camera on the remote console; and
perform an action based on a feedback from the remote console, wherein the feedback is generated corresponding to the collected logs and the displayed information.

10. The real-time remote troubleshooting system of claim 9, wherein the digital video recorder is configured to:
in response to receiving a command from the troubleshooting apparatus, provide the information associated with the digital video recorder or the body-worn camera to the troubleshooting apparatus.

11. The real-time remote troubleshooting system of claim 9, wherein the digital video recorder is configured to:
store a plurality of images captured by the body-worn camera in a database;
receive a command from the remote console via the troubleshooting apparatus;
query the database based on the command to generate a query result; and
display the query result on the remote console.

12. A real-time remote troubleshooting method, suitable for an electronic device that is communicatively connected with a device and a remote console, wherein the method comprises:
receiving a request for remote access to the device from the remote console;
providing the remote console with the remote access to the device based on the request;
collecting logs associated with the device;
displaying the collected logs on the remote console;
displaying information associated with the device on the remote console; and
performing an action based on a feedback from the remote console, wherein the feedback is generated corresponding to the collected logs and the displayed information.

13. The real-time remote troubleshooting method of claim 12, wherein the electronic device provides a user interface, and the method further comprises:
receiving the request for remote access to the device from the remote console through the user interface;
providing the remote console with the remote access to the device through the user interface, based on the request;
displaying the collected logs on the remote console through the user interface; and
displaying the information associated with the device on the remote console through the user interface.

14. The real-time remote troubleshooting method of claim 12, further comprising:
selecting a specific log type from a plurality of log types corresponding to the collected logs; and
displaying the collected logs associated with the specific log type on the remote console.

15. The real-time remote troubleshooting method of claim 12, further comprising:
obtaining a specific time duration; and
collecting the logs associated with the device for the specific time duration.

16. The real-time remote troubleshooting method of claim 12, wherein the electronic device is communicatively connected to a plurality of remote consoles, and the method further comprises:
receiving a plurality of requests for remote access to the device from the remote consoles respectively;
granting one of the requests;
providing one of the remote consoles with remote access to the device, based on the granted request; and
displaying the information associated with the device on the one of the remote consoles corresponding to the granted request.

17. The real-time remote troubleshooting method of claim 12, further comprising:
sending a command to the device to generate a screenshot of the device;
obtaining the screenshot from the device; and
displaying the screenshot of the device on the remote console.

18. The real-time remote troubleshooting method of claim 12, further comprising:
sending a command to the device to query a database of the device;
obtaining a query result corresponding to the command from the device; and
displaying the query result of the device on the remote console.

19. The real-time remote troubleshooting method of claim 12, further comprising:
displaying a plurality of user interface components on the remote console;
selecting one of the user interface components based on a display parameter; and
displaying the selected user interface component corresponding to the display parameter.
